(19) United States
(12) Patent Application Publication
(10) Pub. No.: US 2026/0329869 A1
(43) Pub. Date: Oct. 22, 2026

(54) PROVIDING CUSTOMIZED SERVICES TO USERS OF DATA PROCESSING SYSTEMS BASED ON EQUIVALENT DATA

(71) Applicant: Dell Products L.P., Round Rock, TX (US)

(72) Inventors: TSEHSIN JASON LIU, Wellesley, MA (US); VINAY SAWAL, Fremont, CA (US); CHING-YUN CHAO, Austin, TX (US); AMIHAI SAVIR, Newton, MA (US)

(21) Appl. No.: 19/183,404

(22) Filed: Apr. 18, 2025

(51) Int. Cl. G06F 16/3332; G06F 16/35

(52) U.S. Cl. CPC G06F 16/24575; G06F 16/3332; G06F 16/35; G06F 16/248

(57) ABSTRACT

Methods and systems for providing customized services to users of data processing systems are disclosed. To provide the customized services, a query may be obtained from a user. Contextual information for the query may be attempted to be obtained from a first data source associated with the user. Other data sources may be identified from which supplemental contextual information may be obtained. To obtain the supplemental contextual information, a prompt based on the query may be issued to the other data sources. The prompt may be translated using an equivalency repository to obtain a translated prompt that includes a term that is part of a second taxonomy set that is not part of a taxonomy set used by the first data source. The equivalency repository may include equivalency definitions for different taxonomy sets used with respect to metadata used in the different data sources.

### FIELD

Embodiments disclosed herein relate generally to providing customized services to users of data processing systems. More particularly, embodiments disclosed herein relate to systems and methods to provide customized services to users of data processing systems using a taxonomy translation process to obtain equivalently relevant data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIGS. 3A-3B show flow diagrams illustrating a method for providing customized services to users of data processing systems in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services to users of data processing systems. To provide the computer-implemented services, data may be obtained from any number of distributed data sources (e.g., various databases and/or other storage architectures). The data may be obtained via performing searches across the distributed data sources, which may consume an undesirable amount of resources (e.g., cognitive resources of the users, time resources, computational resources).

To reduce a resource consumption for obtaining the data, the users may obtain the data using inference models. The inference models may include generative artificial intelligence (AI) models such as large language models (LLMs) and may be trained to generate responses when provided with queries from the users. The responses may include the data usable to provide the computer-implemented services.

However, the responses generated by the inference models may not meet the expectations of the users. For example, a response may not meet the expectations of a user due to an inability of the user to generate a query in a manner that allows an inference model to generate a desired response (e.g., the query may be ambiguous, lack context, and/or otherwise fail to obtain the desired response from the inference model). In another example, an inference model may be trained using an insufficient quantity of training data. Due to the insufficient quantity of training data, the inference model may require complex and/or specific queries in order to generate a desired response. Therefore, the responses may be of a reduced quality which may result in cessation of and/or a reduction in quality of the computer-implemented services provided, at least in part, using the responses.

To provide responses to users of data processing systems that meet the expectations of the users while conserving resources, contextual information for queries obtained from the users may be obtained from data sources associated with the users and/or from other data sources associated with other users. To do so, a first personal agent may be assigned to a user and, upon obtaining a query from the user, the first personal agent may attempt to obtain the contextual information for the query from a first data source (e.g., a first retrieval-augmented generation (RAG) repository) associated with the user. If at least a first portion of the contextual information is unable to be obtained from the first data source, the first personal agent may identify other users with, for example, similar and/or different characteristics based on the user.

It may be identified that at least a portion of the other users uses a different taxonomy set with respect to metadata (e.g., hierarchical descriptions for data chunks defined by the user). When attempting to obtain the contextual data from the other data sources that use a different taxonomy set, the first agent may receive limited information from other agents of the other data sources due to a likelihood that the other agents may not understand a prompt issued by the first agent using a first taxonomy set. For example, the prompt may include a term that a second agent may not understand and may subsequently limit relevant information provided by the second agent from a second data source.

To improve a likelihood that desired contextual information may be obtained to service a query issued by a user, a metadata translation process may be performed to obtain a translated prompt for a data source that uses a different taxonomy set than a first taxonomy set used by the user and the first data source. To do so, agents for the data sources may utilize an equivalent repository that may host equivalency definitions that enable two or more portions of metadata to be translated based a desired taxonomy set.

The portions of the metadata may be obtained for a data chunk indicated to be of interest to a user. For example, the user may bookmark a data chunk (e.g., a document, an email, a portion of a codebase, etc.). The data chunk may be tagged by the user and/or an agent assigned to the user to indicate relevant information regarding the data chunk. For example, the data chunk may be tagged by the agent based on a taxonomy set defined by the user. Second metadata for the data chunk may be obtained from a second data source and identified to use a second taxonomy set.

As such, the first metadata and the second metadata for the data chunk may be deemed to be equivalent (e.g., based on an identified relationship between the first metadata and the second metadata, a mapping between the first metadata and the second metadata as indicated by a user, etc.) and an equivalency definition may be stored in the equivalency repository so that the first metadata and the second metadata may be mutually translatable to the desired taxonomy set during retrieval of desired contextual information from a data source that uses a different taxonomy set.

Furthermore, the metadata translation process may be performed, for example, by translating a prompt generated by a first agent (e.g., a prompt sending agent) to send a translated prompt to a second agent (e.g., a receiving agent) and/or by sending a prompt to be translated by the second agent. By doing so, the second agent (and/or other agents of other data sources that use different taxonomy sets than the first data source) may be more likely to provide desired contextual information (e.g., relevant data chunks) for servicing the query of the user.

The query may be serviced by generating an ingest data package for the inference model. The ingest data package may include: (i) the at least the supplemental information, (ii) any other information obtained from the first data source while attempting to obtain the contextual information, and/or (iii) the query. The ingest data package may then be used to initiate generation of a response to the query by an inference model, and the response may be provided to the user as a customized service.

Thus, embodiments disclosed herein may address, among other technical problems, the technical challenge of providing information to users of data processing systems while the different users may use different sets of taxonomy. To provide the information to the users, contextual information for queries from the users may be obtained from data sources associated with the users and data sources associated with other users selected based on the users. The contextual information may then be used as context by an inference model to generate responses to the queries including the information. By doing so, a likelihood of providing the information to the users as desired may be improved. By utilizing inference models to provide the information to the users, a resource expenditure of obtaining the information may be reduced.

In an embodiment, a method for providing customized services to users of data processing systems is disclosed. The method may include: (i) making an identification that sufficient contextual information for a query is unavailable from a first data source; (ii) based on the identification: (a) identifying a plurality of other data sources; (b) identifying that at least a portion of the plurality of other data sources use a different taxonomy set with respect to metadata for the portion of the plurality of other data sources; (c) performing a metadata translation process using an equivalency repository to obtain at least one translated prompt for the plurality of other data sources; (d) obtaining, using the translated prompt, supplemental contextual information for the query from the other data sources; and (e) servicing the query using at least the supplemental contextual information and any other information obtained from the first data source.

The method may also include: (i) obtaining, from the first data source, first metadata for a data chunk; (ii) obtaining, from a second data source of the other data sources, second metadata for the data chunk; (iii) identifying at least one portion of the first metadata and at least one second portion of the second metadata that are deemed to be equivalent to obtain an equivalency definition; and (iv) storing the equivalency definition in the equivalency repository so that the at least one portion of the first metadata and the at least one second portion of the second metadata are mutually translatable.

The first data source may use a first taxonomy set to describe a topic of the data chunk and the second data source uses a second taxonomy set to describe the topic of the data chunk.

The method may also include: (i) identifying a new data chunk indicated to be of interest by a user of the first data source; and (ii) obtaining metadata for the new data chunk.

Obtaining the metadata for the new data chunk may include: (i) tagging, by an agent of the first data source, the new data chunk based on the first taxonomy set, the first taxonomy set being defined by the user of the first data source, and the second taxonomy set being defined by a different user.

Performing the metadata translation process may include: (i) generating, by an agent of the first data source, a prompt based on the query to retrieve at least a portion of the supplemental contextual information from a second data source of the plurality of data sources; (ii) translating, by the agent, the prompt using the equivalency repository to obtain a translated prompt to be processed by a second agent of the second data source, the translated prompt comprising a term that is: (a) not present in the prompt; (b) indicated, by the equivalency repository, as equivalent to a second term that is present in the prompt; and (c) part of a second taxonomy set used the second agent; and (iii) providing the translated prompt to the second agent.

Performing the metadata translation process may include: (i) generating, by an agent of the first data source, a prompt based on the query to retrieve at least a portion of the supplemental contextual information from a second data source of the plurality of data sources; (ii) providing, by the agent, the prompt to a second agent of the second data source; and (iii) translating, by the second agent, the prompt using the equivalency repository to obtain the translated prompt, the translated prompt comprising a term that is: (a) not present in the prompt; (b) indicated, by the equivalency repository, as equivalent to a second term that is present in the prompt; and (c) part of a second taxonomy set used the second agent.

The metadata may indicate hierarchical information based on content of data chunks hosted by data sources, the data chunks being deemed relevant by the users.

The hierarchical information may indicate a version of a topic to which a data chunk of the data chunks relates.

The first data sources may be associated with a user of the users and managed by a first agent assigned to the user, the first data source serving as a personal context library for the user for queries submitted to the first agent.

The supplemental contextual information may be used along with a prompt as input to an artificial intelligence model of the first agent.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

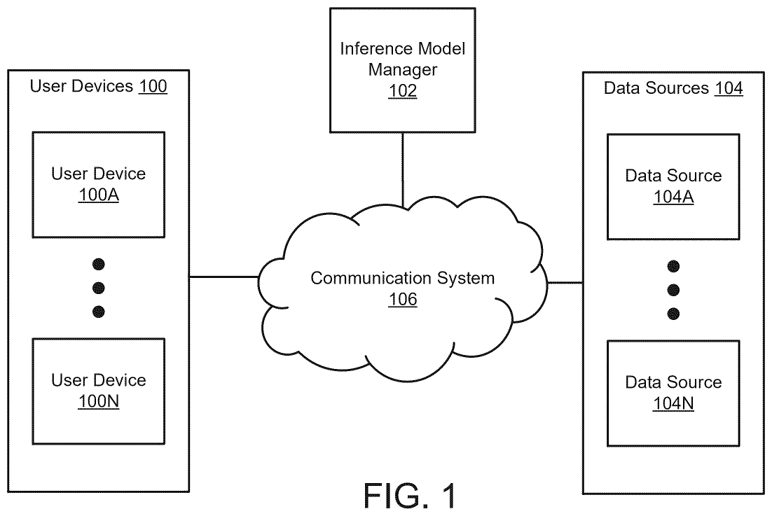

Turning to FIG. 1, a block diagram illustrating a system in accordance with an embodiment is shown. The system shown in FIG. 1 may provide, at least in part, computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided by, for example, user devices 100, inference model manager 102, data sources 104, and/or any other type of devices (not shown in FIG. 1). Other types of computer-implemented services may be provided by the system shown in FIG. 1 without departing from embodiments disclosed herein.

Information obtained from data sources 104 may be used, at least in part, to provide the computer-implemented services. For example, a user of user device 100A may be a salesperson that analyzes market trends for a company. In order to analyze the market trends, the salesperson may use information such as historical sales data for the company, sales data from other companies, regional and/or global market data, forecasted market data, etc.

The information used by the user may be stored in any number of distributed data sources of data sources 104. For example, the information used by the salesperson may be stored in various databases and/or other data repositories. Searching for the information across the distributed data sources may consume an undesirable amount of resources, such as time resources, cognitive resources of the user, and computing resources.

To improve an efficiency of obtaining the information and decrease resource consumption, the user may use an inference model to obtain the information. The inference model may include a generative artificial intelligence (AI) model such as a large language model (LLM). The inference model may be trained to generate responses when provided with a query (e.g., ingest data). The responses may include the information and may be provided as part of the computer-implemented services. For example, the salesperson may provide a query to the inference model indicating a desired information content (e.g., the query may include the text “global sales last quarter”), and the salesperson may obtain a response to the query from the inference model.

However, responses generated by the inference model may not meet expectations of the user (e.g., the responses may not include the desired information content, the responses may not be accurate). For example, the responses may not meet the expectations of the user due to an inability of the user to generate queries in a manner that allows the inference model to generate desired responses. For example, the salesperson may lack training and/or experience using inference models; as a result, queries provided to the inference model by the salesperson may be ambiguous, lack context, and/or otherwise fail to obtain a response from the inference model that meets the expectations of the salesperson. In another example, an inference model may be trained using an insufficient quantity of training data. Due to the insufficient quantity of training data, the inference model may require complex and/or specific queries in order to generate desired responses. Consequently, the user may be unable to obtain desired responses, and the computer-implemented services provided, at least in part, based on the responses may be negatively impacted.

In general, embodiments disclosed herein may provide methods, systems, and/or devices for providing customized services to users of data processing systems in a manner that meets the expectations of the users while conserving resources. To provide the customized services, a query may be obtained from a user. To obtain a response for the query that meets the expectations of the user, contextual information may be provided, in addition to the query, as ingest to an inference model to be used to generate the response.

The contextual information may be obtained from a first data source (e.g., a first RAG repository) associated with the user. The first data source may be managed by an agent (e.g., personal agent) assigned to the user. As such, the first data source may serve as a personal context library for the user for queries submitted to the first agent. However, if at least a first portion of the contextual information is unable to be obtained from the first data source, the at least the first portion of the contextual information may be obtained from other data sources.

To attempt to obtain the at least the first portion of the contextual information from other data sources, a plurality of other data sources may be identified and at least one data chunk from the other data sources may be obtained. To obtain the data chunks from the other data sources, the first agent may generate and provide a prompt to other agents of each of the other data sources based on the query. Each of the other agents may attempt to retrieve relevant data chunks based on metadata of the data chunks hosted by the other data sources. Because the other data sources may use a different taxonomy set with respect to metadata (e.g., hierarchical descriptions for data chunks defined by the user), a quality of information obtained from the first agent using the prompts may be negatively impacted. For example, the prompt may include a term that a second agent may not understand and may subsequently limit relevant information provided by the second agent from a second data source.

For example, returning to the previous scenario in which the salesperson issues a query to an agent for the salesperson, the salesperson may issue a query to obtain information about potential customers (e.g., “provide contact information for sales leads”). A data source for the salesperson may limited information, so the agent may issue the prompt to other agents of other users and data sources (e.g., in an organization of the salesperson). One of the users may include, for example, a sales manager that may use a different taxonomy set. For example, the sales manager may tag contact information for potential customers using a different term (e.g., “pipeline opportunities”), organize attributes for customers in a different manner, and/or otherwise perform actions in accordance with other sales managers. In this scenario, the agent for the sales manager may not retrieve relevant information based on the prompt issued by the agent for the salesperson.

To improve a likelihood that desired contextual information may be obtained to service a query issued by a user, a metadata translation process may be performed to obtain a translated prompt for a data source that uses a different taxonomy set than a first taxonomy set used by the user and the first data source. To do so, agents for the data sources may utilize an equivalent repository that may host equivalency definitions that enable two or more portions of metadata to be translated based a desired taxonomy set.

The portions of the metadata may be obtained for a data chunk indicated to be of interest to a user. For example, the user may bookmark a data chunk (e.g., a document, an email, a portion of a codebase, etc.). The data chunk may be tagged by the user and/or an agent assigned to the user to indicate relevant information regarding the data chunk. For example, the data chunk may be tagged by the agent based on a taxonomy set defined by the user. Second metadata for the data chunk may be obtained from a second data source and identified to use a second taxonomy set.

As such, the first metadata and the second metadata for the data chunk may be deemed to be equivalent (e.g., based on an identified relationship between the first metadata and the second metadata, a mapping between the first metadata and the second metadata as indicated by a user, etc.) and an equivalency definition may be stored in the equivalency repository so that the first metadata and the second metadata may be mutually translatable to the desired taxonomy set during retrieval of desired contextual information from a data source that uses a different taxonomy set.

Furthermore, the metadata translation process may be performed, for example, by translating a prompt generated by a first agent (e.g., a prompt sending agent) to send a translated prompt to a second agent (e.g., a receiving agent) and/or by sending a prompt to be translated by the second agent. For example, returning to the previous example, the terms (e.g., “sales leads” and “pipeline opportunities”) may be identified to be equivalent with respect to the different users. The first agent and/or the second agent may translate the prompt to include a version of the term more likely to be understood by the receiving agent to facilitate retrieving relevant data chunks. By doing so, the second agent (and/or other agents of other data sources that use different taxonomy sets than the first data source) may be more likely to provide desired contextual information (e.g., relevant data chunks) for servicing the query of the user.

To provide the above noted functionality, the system of FIG. 1 may include user devices 100, inference model manager 102, data sources 104, and communication system 106. Each of these components is discussed below.

User devices 100 may provide and/or consume all, or a portion of, the computer-implemented services. User devices 100 may include any number of user devices (e.g., 100A-100N), that may be used by businesses, individuals, and/or other users. User devices 100 may include data processing systems including any number of hardware and/or software components configured to provide the computer-implemented services. While providing the computer-implemented services, user devices 100 may obtain responses from inference models and/or other information based on the responses to facilitate provisioning of the computer-implemented services.

To obtain the responses, user devices 100 may host personal agents (e.g., a software program) and/or may communicate with personal agents hosted by a remote entity (not shown). The personal agents may each be assigned to a user of user devices 100, and may interact with the users, other personal agents, and/or inference model manager 102 to facilitate provision of the computer-implemented services. To perform their functionality, the personal agents may: (i) store files, emails, documents, and/or other types of data ascribed predetermined levels of importance by the users (e.g., based on any criteria and/or schema for assigning levels of importance) in data sources 104, (ii) obtain queries (e.g., from their assigned users), (iii) generate translated prompts based on the query using an equivalency repository, (iv) obtain contextual information using the translated prompts (e.g., from data sources 104, from other personal agents), (v) obtain, using the contextual information and the queries, ingest data packages for the inference models (e.g., generate the ingest data packages), (vi) provide the ingest data packages to inference model manager 102 (e.g., to be used as input for generating responses), (vii) receive responses to the queries from inference model manager 102, and/or perform other tasks.

The personal agents may obtain the contextual information for the queries from data sources 104 and/or from other personal agents. Data sources 104 may include any type and/or number of data sources (e.g., 104A-104N). Each data source of data sources 104 may include hardware and/or software components configured to obtain data, store data, provide data to other entities, and/or to perform any other task to facilitate performance of the computer-implemented services. All, or a portion, of data sources 104 may provide (and/or participate in and/or support the) computer-implemented services to various devices operably connected to data sources 104. Different data sources may provide similar and/or different computer-implemented services.

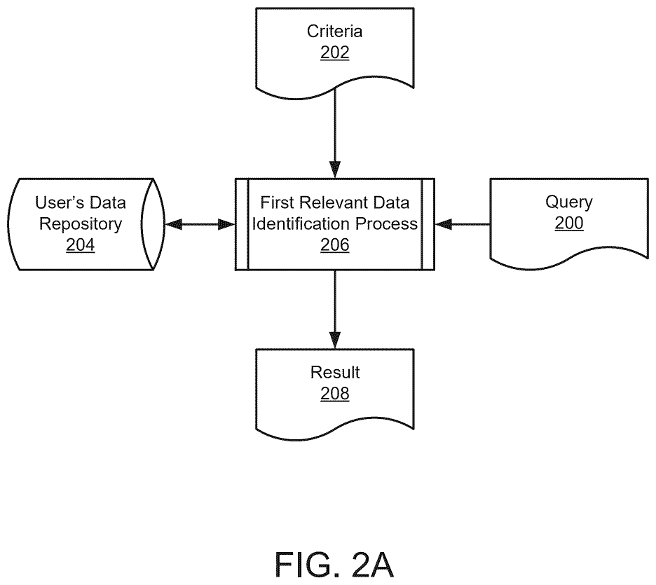

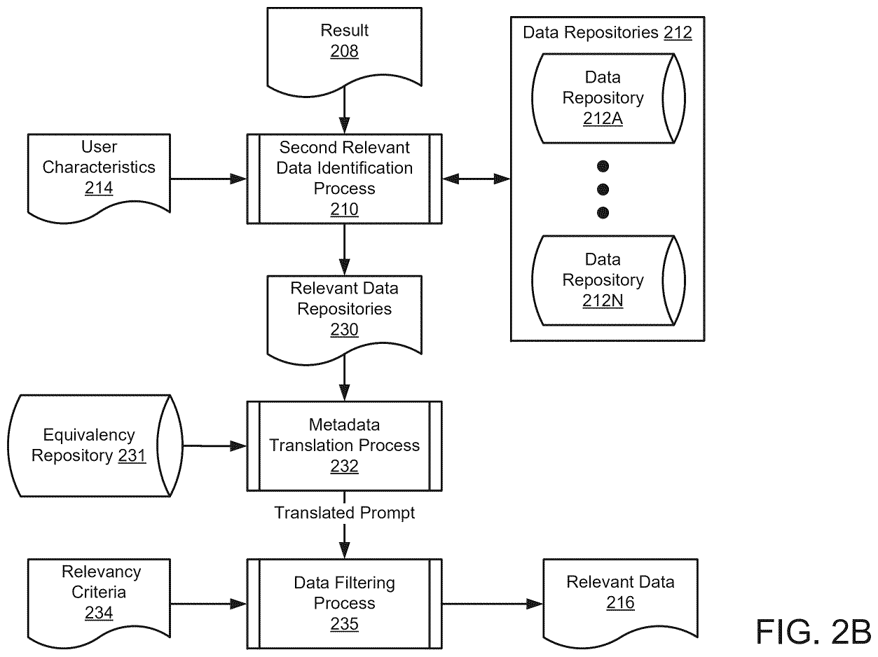

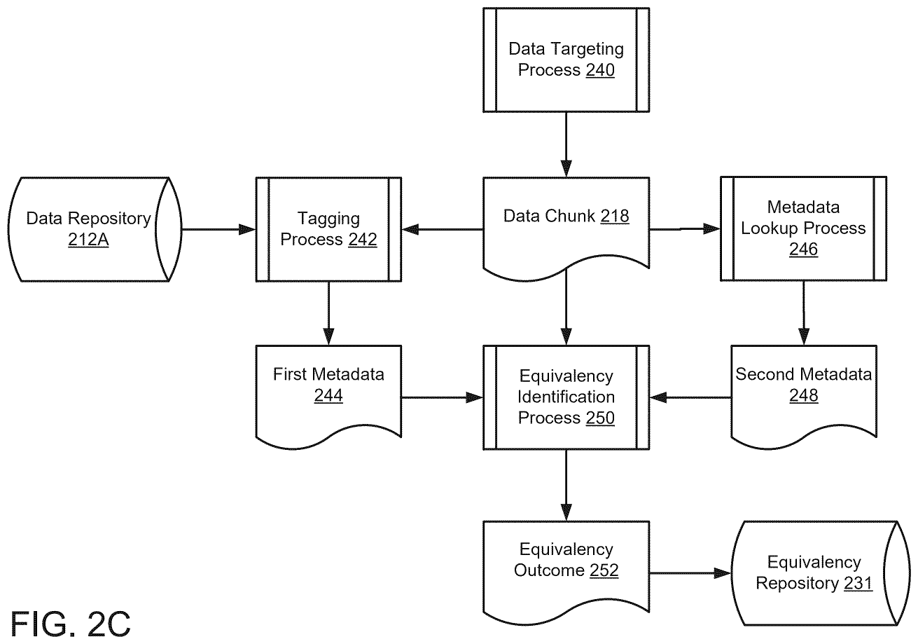

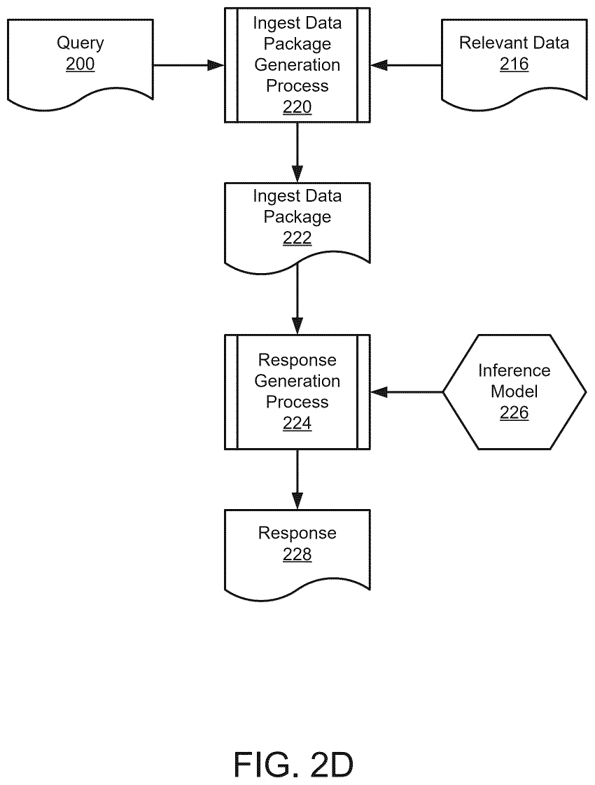

Data sources 104 may include RAG repositories, and may provide data to (e.g., allow access to data by) the personal agents. Data sources 104 may be organized so that each data source of data sources 104 (e.g., each RAG repository) is associated with a user of user devices 100, and a personal agent assigned to a user may be allowed to store, modify, and/or access the data in a data source associated with the user. For example, data source 104A may be associated with a user of user device 100A, and thus, the personal agent assigned to the user of user device 100A may be allowed access to data source 104A. Refer to the description of FIG. 2A for additional details regarding the data sources.

To obtain the contextual information for the queries, the personal agents may first attempt to obtain the contextual information from data sources associated with their assigned users. If at least a first portion of the contextual information is unable to be obtained, the personal agents may initiate interactions with other personal agents to attempt to obtain the at least the first portion of the contextual information from other data sources of data sources 104. The other data sources used to attempt to obtain the at least the first portion of the contextual information may be selected based on characteristics of users associated with the other data sources.

For example, a first personal agent hosted by user device 100A may obtain a query from the user of user device 100A. Upon obtaining the query, the first personal agent may attempt to obtain the contextual information for the query from data source 104A (e.g., a RAG repository associated with the user). If the first personal agent is unable to obtain at least a first portion of the contextual information from data source 104A, the first personal agent may generate a prompt to be processed by at least one other personal agent for other data sources. Because the other data sources may use different taxonomy sets (e.g., describe data using different terms), the first personal agent and/or the other personal agents may translate the prompt to include a term that is not present in the prompt and indicated by an equivalence repository to be equivalent to a second term that is present in the prompt. In response, the other personal agents may provide the requested information to the first personal agent. Refer to the description of FIG. 2B for additional details regarding obtaining the at least the first portion of the contextual information.

Once other data sources are identified, data chunks stored within the various data sources may be obtained and filtered (e.g., subject to a filtering process using, at least in part, available metadata for the data chunk, a metadata relevancy hierarchy, and/or relevancy criteria) to obtain supplemental contextual information for the query. The filtering process may include performing an analysis of each data chunk to identify metadata relevancy outcomes (e.g., metadata of the data chunk that may be relevant to the query), assign a relevancy level to the respective data chunk based on the metadata relevancy outcomes, and conclude whether the data chunk should be added to the supplemental contextual information to obtain sufficient contextual information for the queries.

Upon obtaining sufficient contextual information for the queries (e.g., based on any criteria for an amount of information needed to generate responses as desired by the users), the personal agents may obtain ingest data packages for the inference models, which may include any relevant contextual information for the query (e.g., from data sources associated with their assigned users, from other personal agents) and/or the query. The ingest data packages may be obtained as part of performing a retrieval-augmented generation (RAG) pipeline process.

The ingest data packages may be provided to inference model manager 102. Inference model manager 102 may perform tasks relating to management of and/or facilitation of use of inference models. Inference model manager 102 may include any number and/or type of devices (e.g., other data processing systems, servers, storage devices, user devices) that may be used to manage the inference models. As part of managing the inference models, inference model manager 102 may train and/or host any number and/or type of inference models trained to generate responses (e.g., inferences) to queries. The inference models may include generative artificial intelligence (AI) inference models (e.g., large language models (LLMs)); therefore, the responses may include new instances of data created by the generative AI inference models based on learned associations established during inference model training. For example, the inference models may be trained using unstructured data, such as stories, essays, audio transcription, video description, and/or other types of human interpretable text, to generate responses of the same. The ingest data packages provided to inference model manager 102 by the personal agents hosted by user devices 100 may be used as input data for the inference models managed by inference model manager 102.

To perform its functionality, inference model manager 102 may: (i) manage (e.g., facilitate) training processes for the inference models (e.g., LLMs, other types of inference models), (ii) obtain ingest data packages, (iii) use the ingest data packages to initiate generation of responses to the queries using the ingest data packages as input (e.g., by feeding the ingest data packages to the inference models and obtaining the responses as output from the inference models), (iv) provide the responses to user devices 100 as customized services, and/or (v) perform other tasks. The responses may be generated by the inference models using the contextual information provided as part of the ingest data packages as context for the responses.

Thus, personal agents assigned to users of user devices 100 may facilitate obtaining responses to queries from the users. To do so, the personal agents may first attempt to obtain contextual information for the queries from a data source of data sources 104 associated with their assigned users. If at least a first portion of the contextual information is unable to be obtained, the personal agents may interact with other personal agents to obtain the at least the first portion of the contextual information from other data sources of data sources 104. Any information identified as relevant contextual information may be provided as part of an ingest data package to inference models managed by inference model manager 102. By doing so, a likelihood of obtaining responses to the queries in a manner that meets the expectations of the users may be increased.

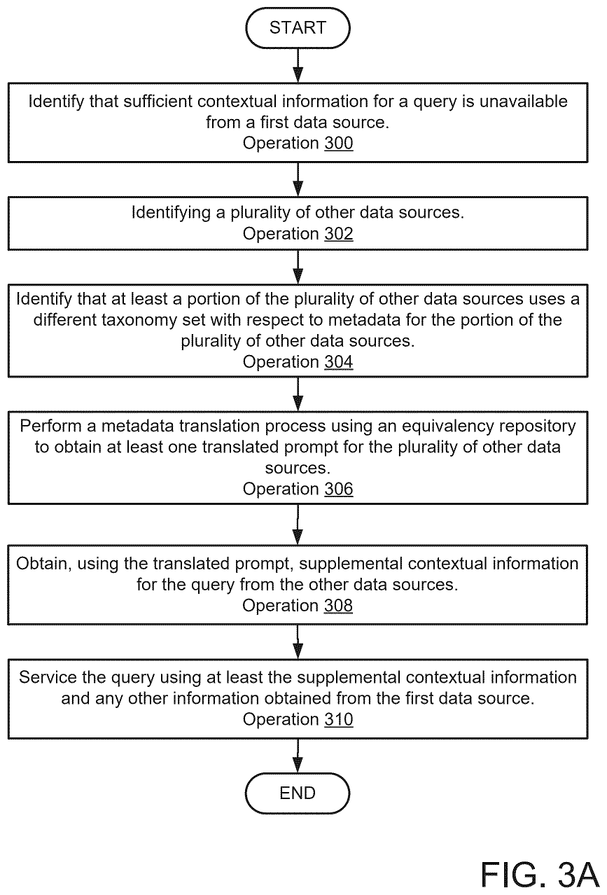

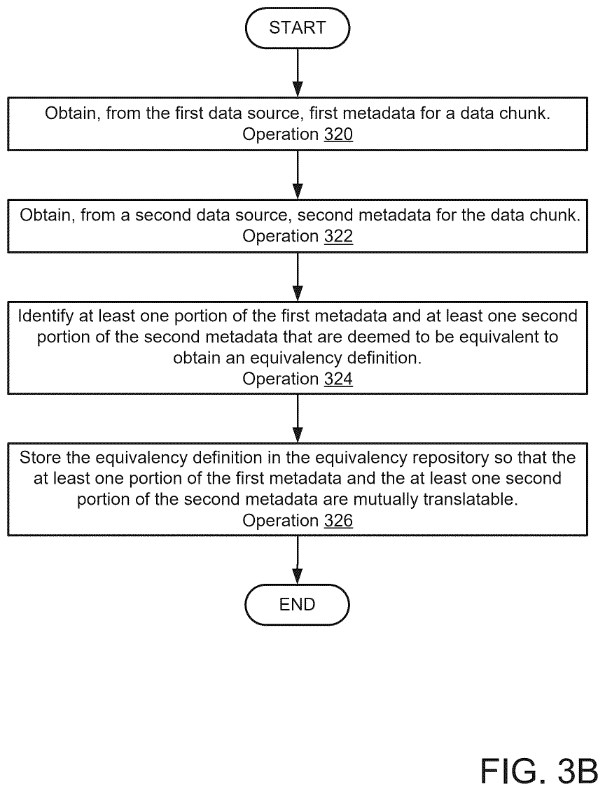

When providing their functionality, any of (and/or components thereof) user devices 100, inference model manager 102, and/or data sources 104 may perform all, or a portion, of the actions and methods illustrated in FIGS. 2A-3B.

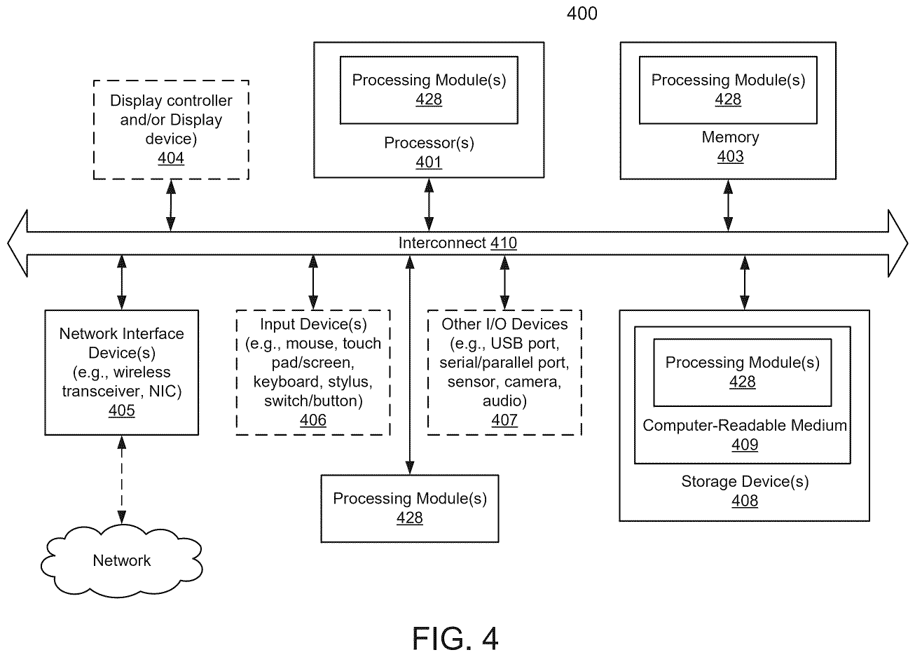

Any of (and/or components thereof) user devices 100, inference model manager 102, and data sources 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 200, 202, etc.) is used to represent data structures, a second set of shapes (e.g., 206, 210, etc.) is used to represent processes performed using and/or that generate data, a third set of shapes (e.g., 204, 212A) is used to represent large scale data structures such as databases, and a fourth set of shapes (e.g., 226) is used to represent inference models.

Turning to FIG. 2A, a first data flow diagram in accordance with an embodiment is shown. The first data flow diagram may illustrate data used in and data processing performed in attempting to obtain contextual information for a query from a user (e.g., query 200) from a first data source associated with the user (e.g., user's data repository 204).

To do so, query 200 may be obtained from the user. For example, query 200 may be obtained by a first personal agent assigned to the user (e.g., via a message over a communication system from the user, via input by the user using a graphical user interface (GUI) on the user's device).

Query 200 may include a prompt (e.g., a question, a request for a desired information content and/or other information) to be used as a guide and/or instructions by an inference model (e.g., an LLM) to generate a response. For example, an employee of a company may use an LLM to generate a summary of past sales for the company based on query 200 (e.g., the desired information content). In this example, query 200 may include the text “summarize sales for last quarter” which may be used by the LLM to generate an output (e.g., a response). In another example, the employee may use the LLM to obtain an answer to a question included in query 200 that may include the text “how do I log into the account management software” which may be used by the LLM to generate a response.

In order to provide the response to query 200 that meets the expectations of the user (e.g., the user may expect the response to include accurate information and/or the desired information content), contextual information may be obtained to be used by the inference model as context for generating the response. To obtain the contextual information, first relevant data identification process 206 may be performed. During first relevant data identification process 206, the contextual information may be attempted to be obtained (e.g., by the first personal agent) from a first data source (e.g., a first RAG repository) associated with the user (e.g., user's data repository 204). User's data repository 204 may be managed by the first personal agent, and may include first content ascribed a predetermined level of importance by the user (e.g., based on any criteria and/or schema for assigning levels of importance).

For example, user's data repository 204 may include entries such as documents, emails, presentations, recordings, templates, etc. which the user deems to be important and/or references (e.g., bookmarks) to information the user deems to be important. For example, if the user deems an email to be important, the user may add a copy of the email to user's data repository 204, and/or the user may add a reference to the email to user's data repository 204. The reference may then be used to retrieve information from the email (e.g., during a RAG pipeline process).

The user may add the entries to user's data repository 204 by providing instructions to their assigned personal agent. The instructions may include the information the user desires to be added, as well as a level of importance (e.g., based on a numerical scale and/or any other method for designating levels of importance). For example, the level of importance may be based on a schema and/or rule set for assigning a numerical value from 1-5 to entries in user's data repository 204, where a higher value indicates that an entry is more important.

Continuing the above example, the employee may use a first data source associated with the employee to store company sales reports and emails (e.g., from entities within the company, from other entities). The employee may add entries to the first data source by instructing their assigned personal agent to add content ascribed a level of importance by the employee to the first data source. For example, the employee may provide the instructions “save this email with a level 3 importance” (e.g., based on a scale of 1-10, where 10 indicates the highest level of importance) to their personal agent.

To attempt to obtain the contextual information as part of performing first relevant data identification process 206, query 200 may be analyzed to identify words and/or phrases which may require context in order to be interpreted as desired by the LLM. A search may then be performed in user's data repository 204 using the identified words and/or phrases as keywords for the search to identify any relevant entries which may be used to provide context to the identified words and/or phrases. For example, query 200 may include the text “summarize sales for last quarter.” Based on the text, it may be identified that the word “sales” and the phrase “last quarter” require contextual information in order to obtain a desired response to query 200.

Information obtained from entries from user's data repository 204 that were identified during the search may be compared to criteria 202. Criteria 202 may be provided by a user, a management entity, a subject matter expert (SME), and/or any other entity participating in obtaining responses from inference models. Criteria 202 may include any number of thresholds, rule sets, and/or other means of determining whether an amount of contextual information obtained from user's data repository 204 is considered acceptable. For example, criteria 202 may include a level of enhancement threshold to allow query 200 to be serviced in a manner that is acceptable to the user. The level of enhancement threshold included in criteria 202 may include:
(i) a threshold number and/or percentage of identified words and/or phrases for which contextual information was identified from user's data repository 204, and/or (ii) other thresholds.

If a quantity of the information obtained from the entries from user's data repository 204 meets a corresponding level of enhancement threshold of criteria 202, it may be concluded that the contextual information is able to be obtained from the first data source (e.g., user's data repository 204). Query 200 may then be serviced using the contextual information. Refer to the description of FIG. 2D for additional details regarding servicing query 200.

If a quantity of the information obtained from the entries from user's data repository 204 does not meet the corresponding level of enhancement threshold of criteria 202, it may be concluded that at least a first portion of the contextual information is unable to be obtained from the first data source. The at least the first portion of the contextual information may then be attempted to be obtained from other data sources associated with other users. Refer to the description of FIG. 2B for additional details regarding attempting to obtain the at least the first portion of the contextual information from the other data sources.

For example, an analysis of query 200 may identify 5 words for which contextual information is needed. A search may be performed in user's data repository 204, which may result in information being obtained for 4 of the 5 words. Criteria 202 may include a level of enhancement threshold that indicates information for 75% of the identified words must be obtained in order to service query 200. Therefore, in this example, a quantity of the information obtained from user's data repository 204 may meet the level of enhancement threshold, and thus, the information may meet criteria 202.

While described above with respect to a single quantity from the information obtained from the first data source being compared to a single corresponding threshold from the criteria, it will be appreciated that any number of quantities may be compared to any number of corresponding thresholds and/or any other types of rules may be applied to determine whether criteria 202 are met.

As a result of first relevant data identification process 206, result 208 may be obtained. Result 208 may include: (i) an indication of whether criteria 202 are met (e.g., a “yes” or “no” answer), (ii) portions of query 200 (e.g., identified words and/or phrases) for which sufficient contextual information was unable to be obtained, (iii) any information obtained from user's data repository 204 usable to provide context to portions of query 200, and/or (iv) other information.

Turning to FIG. 2B, a second data flow diagram in accordance with an embodiment is shown. The second data flow diagram may illustrate data used in and data processing performed, at least in part, in obtaining at least a first portion of contextual information for query 200 from other data sources associated with other users (e.g., users other than the user that provided query 200).

To attempt to obtain the at least the first portion of the contextual information, second relevant data identification process 210 may be performed. During second relevant data identification process 210, portions of query 200 for which sufficient contextual information was unable to be obtained may be identified from result 208 (e.g., a list of identified words and/or phrases for which contextual information was unable to be obtained from a first data source). The at least the first portion of the contextual information for the identified portions of query 200 may be attempted to be obtained (e.g., by a first personal agent assigned to the user) from data repositories 212.

Data repositories 212 may include any number of data repositories (e.g., 212A-212N) (e.g., RAG repositories) associated with other users and managed by personal agents assigned to the other users. For example, data repository 212A may be a second data source associated with a second user and managed by a second personal agent. Data repositories 212 may be used by the other users to store content similar to content stored in user's data repository 204 shown in FIG. 2A.

To attempt to obtain the at least the first portion of the contextual information, a subset of data repositories 212 may be identified that is likely to include information relevant to the user that provided query 200. By attempting to obtain the at least the first portion of the contextual information from data sources likely to be relevant to the user, a likelihood of obtaining a response to query 200 that meets the expectations of the user may be improved.

To obtain the subset of data repositories 212, at least one other user may be identified based on the user using user characteristics 214. User characteristics 214 may include: (i) first characteristics for the user, and/or (ii) characteristics for the other users. The first characteristics may include: (i) a job title for the user (e.g., a position of the user within a company), (ii) job duties for the user (e.g., roles and/or tasks performed by the user), (iii) a job division for the user (e.g., a department that the user is associated with within the company), (iv) a job ranking for the user (e.g., a level of experience for the user), (v) a geographic location for the user (e.g., a country), and/or (vi) other characteristics for the user. The characteristics for the other users may include similar information for each user of the other users. User characteristics 214 may be obtained from a characteristics database, repository, and/or other storage architecture that may be maintained, for example, by a company for employees of the company.

To identify the at least one other user, a user matching process may be performed as part of performing second relevant data identification process 210. During the user matching process, the first characteristics may be compared to the characteristics for the other users to identify the at least one other user having second characteristics that meet similarity criteria (not shown). Performing the user matching process may include performing any number and/or type of analysis processes using any similarity criteria (e.g., determined by the user, a management entity, a SME, and/or any other entity). For example, the similarity criteria may include a threshold number and/or percentage of the first characteristics which match characteristics of the at least one other user.

For example, a query including the text “instructions for using software” may be obtained from a new employee at a company by a first personal agent assigned to the new employee. The first characteristics for the new employee may indicate that the new employee is an engineer, responsible for writing technical reports and using software to create schematics, works in the product development division of the company, and is an entry-level employee. The first personal agent may attempt to obtain contextual information for the query from a first data source associated with the new employee. If the first personal agent is able to obtain the contextual information from the first data source, the first personal agent may use the contextual information to service the query. Refer to the description of FIG. 2D for additional details regarding servicing the query.

If the first personal agent determines that at least a first portion of the contextual information for servicing the query is unable to be obtained from the new employee's data source, the new employee's characteristics may be compared to characteristics of other employees at the company using a user matching process. Based on the user matching process, a second employee may be identified that has second characteristics. For example, the second characteristics may indicate that the second employee is an engineer, responsible for writing technical reports and using software to create schematics, works in the product development division of the company, and is a senior-level employee. The similarity criteria may indicate that at least 50% of the first characteristics must match the second characteristics to meet the similarity criteria; thus, in this example, the second characteristics may meet the similarity criteria and the second user may be identified as the at least one other user.

Upon identifying the at least one other user, the subset of data repositories 212 may be identified. For example, a second data source that is associated with the at least one other user may be identified (e.g., data repository 212A) that includes second content ascribed a predetermined level of importance by the at least one other user (e.g., data repository 212A may be used by the at least one other user to store information and a corresponding level of importance). The second data source may be managed by a second personal agent.

To attempt to obtain the at least the first portion of the contextual information from the second data source, the first personal agent may initiate interactions with the second personal agent. For example, the first personal agent may provide a request for information to the second personal agent (e.g., via a message using a communication channel). Upon obtaining the request, the second personal agent may perform a search in the second data source to identity the requested information. The second personal agent may provide a response to the first personal agent, including: (i) an indication regarding whether the requested information was able to be obtained (e.g., a “yes” or “no” answer), (ii) the requested information, and/or (iii) other information. The first personal agent may interact with any number of other personal agents associated with the identified subset of data repositories 212 to attempt to obtain the at least the first portion of the contextual information.

While described with respect to the second personal agent providing the information to the first personal agent upon receiving the request for the information, it will be appreciated that the second personal agent may deny the request for any number of reasons. For example, the request may include first characteristics for the user, and based on the first characteristics, the second personal agent may restrict access to the information by the first personal agent (e.g., based on a role-based access control (RBAC) rule set for data sharing). For example, the first characteristics may indicate that the user is an entry-level employee, and the requested information may be restricted to senior-level employees. In this example, the second personal agent may provide a response to the first personal agent indicating the request is denied.

Once the relevant data repositories (e.g., 230) are identified, metadata translation process 232 may be performed. During metadata translation process 232, a translated prompt may be obtained based on a first prompt issued by the first personal agent. As previously discussed, different users may use different taxonomy sets (e.g., terms to describe data in respective data repositories). As such, to improve a likelihood that relevant data may be retrieved by agents of relevant data repositories 230, the first agent may translate a prompt using equivalency repository 231 to obtain a translated prompt that may, for example, replace a term present in the prompt with a second term that is indicated to be equivalent to the first term and is part of a taxonomy set used by respective agents of relevant data repositories 230. The first agent may also provide the first prompt to the respective agents (e.g., by broadcasting the prompt), whereby the respective agents may translate the prompt using equivalency repository 231 to use respective taxonomy sets used by the respective data repositories of relevant data repositories 230.

Equivalency repository 231 may include any number and/or type of information regarding equivalency definitions that may be used to translate terms used in metadata between different taxonomy sets. The equivalency definitions may be obtained, for example, by obtaining a plurality of metadata for a data chunk, identifying that at least a portion of the plurality of the metadata are equivalent (e.g., semantically equivalent with respect to a topic of the data chunk) to obtain a equivalency definition, storing the equivalency definition and other relevant information (e.g., corresponding user characteristics, identifiers for corresponding data repositories, etc.) in equivalency repository 231, and/or via any other processes. Refer to FIG. 2C for additional information obtaining equivalency definitions for equivalency repository 231.

Using the translated prompt, data filtering process 235 may be performed to retrieve relevant information from the relevant data repositories. During data filtering process 235, data chunks stored in the data repositories (e.g., relevant data repositories 230) may be subjected to any type of analysis process to identify data chunks based on the translated prompt that may be relevant to the query (e.g., query 200).

Any information obtained from the other data repositories and/or personal agents may be compared to criteria to determine whether sufficient contextual information has been obtained to allow query 200 to be serviced in a manner that is acceptable to the user (e.g., criteria 202, refer to FIG. 2A). Relevancy criteria 234 may be used to discriminate a portion of ordered metadata that is authorized for use in enhancement of a query (e.g., query 200).

If the at least the first portion of the contextual information for query 200 is unable to be obtained from the second data source and/or other data sources of the identified subset of data repositories 212, query 200 may be provided to a second user that is likely to have a knowledge base usable to service query 200. The second user may be identified using user characteristics 214 (e.g., to identify the second user based on characteristics indicating the second user is likely to have the knowledge base), using a rule set for assigning users to service queries (e.g., a team leader associated with the user that provided query 200), and/or based on other associations with the user and/or query 200. The second user may service query 200 by providing a response to the user.

If the at least the first portion of the contextual information is able to be obtained from data repositories 212, relevant data 216 may be obtained. Relevant data 216 may include: (i) the at least the first portion of the contextual information and/or any information relevant to query 200 obtained from data repositories 212 as a result of performing second relevant data identification process 210, (ii) any other information obtained from the first data source associated with the user (e.g., from user's data repository 204, refer to FIG. 2A), and/or (iii) other information. Relevant data 216 may then be used to service query 200 using an inference model. Refer to the description of FIG. 2D for additional details regarding servicing query 200.

Turning to FIG. 2C, a third data flow diagram in accordance with an embodiment is shown. The third data flow diagram may illustrate data used in and data processing performed in obtaining equivalency information for metadata with respect to different taxonomy sets used by different data repositories and/or users.

To obtain the equivalency information, data targeting process 240 may be performed. During data targeting process 240, a data chunk may be identified to be relevant and/or of interest to a user. The data chunk (e.g., 218) may be identified via indication by the user that data chunk is important. To do so, the user may, for example, bookmark the data chunk, assign a level of importance to the data chunk, and/or perform any other actions. Data chunk 218 may include any quantity and/or type of data (e.g., documents, image files, audio files, etc.), and may be classified based on specific metadata that describes key attributes of the data.

To classify the data based on metadata, tagging process 242 may be performed. During tagging process 242, data chunk 218 may be assigned hierarchical information (e.g., metadata) based on content of data chunk 218. Data chunk 218 may be tagged by a user, for example, by assigning additional information to the data chunk, organizing the additional information according to a hierarchy, and/or via any other processes. Data chunk 218 may also be tagged by a personal agent assigned to the user. For example, the personal agent may assign the additional information based on previous tagging of historical data chunks by the user from data repository 212A (e.g., that may be directly associated with the user as a personal context library), utilizing natural language processing, and/or via any other processes. The additional information (e.g., assigned by the user and/or the personal agent) may subsequently be based on a taxonomy set used to describe a topic of data chunk 218 by the user. As a result, first metadata 244 may be obtained for data chunk 218 for the user.

First metadata 244 may include any number and/or type of information used to describe and/or classify data chunk 218. For example, the metadata may include categories or labels such as “topic” (e.g., subject or general theme the data relates to), “project” (e.g., a specific project or initiative that the data is part of), “component” (e.g., a specific part or section of the project that the data refers to), “version” (e.g., a particular version or update of the data), etc. The metadata may also include technical identifiers, such as timestamps, user roles, geographical location, and/or any other attributes used for organizing the data in a structured manner. The naming taxonomies for the metadata may be established, for example, by a user, organization, administrator, etc. by which the customized services are provided to users of data processing systems.

To identify other metadata for the data chunk from other data repositories, metadata lookup process 246 may be performed. During metadata lookup process 246, other data repositories (not shown) may be searched to identify second metadata for data chunks at least similar to data chunk 218. The other data repositories may be searched, for example, using an identifier of data chunk 218 (e.g., a name, a uniform resource locator, a document identifier, a topic, etc.), and identifying second metadata 248 associated with data chunk 218 from a second data repository of the data repositories. Second metadata 248 may include information that may be similar to first metadata 244. For example, second metadata 248 may be tagged by a second user and/or a second personal agent for the second user in a similar manner as first metadata 244. However, second metadata 248 may be based on a second taxonomy set used by the second user of a second data repository (e.g., 212B, not shown). For example, a document (e.g., an article) may be identified to be bookmarked as relevant to two different users. A first user may tag the document with metadata that indicates that the “author” of the document is “John Doe”. A second user may tag the document with second metadata that associates an “entity” for the document is “John Doe”.

To obtain an equivalency definition for two or more portions of metadata, equivalency identification process 250 may be performed. During equivalency identification process 250, a portion of first metadata 244 and a second portion of second metadata 248 may be deemed to be equivalent. For example, the first portion and the second portion may be deemed to be equivalent by comparing hierarchical information of first metadata 244 and second hierarchical information of second metadata 248 (e.g., a mapping structure), taxonomy used by the two portions of metadata, and/or via any other processes. The equivalency definition may be identified by at least one of the personal agents, by at least one user, by a subject matter expert, and/or any other entities. Returning to the previous example, the terms “authors” and “entity” may be deemed to be equivalent based on a matching tag for data chunk 218 being “John Doe”.

As a result of equivalency identification process 250, equivalency outcome 252 may be obtained. Equivalency outcome 252 may include the equivalency definition for the first metadata and the second metadata and may be associated with the first user and the second user. Equivalency outcome 252 may be stored in equivalency repository 231 so that prompts issued by a first personal agent of the first user and/or a second personal agent of the second user may translate a prompt using the equivalency definition to improve a likelihood that a receiving agent may retrieve relevant information to be used as contextual information for a query by a user.

Thus, using the data flows shown in FIG. 2C, data chunks indicated as being relevant to a user may be tagged based on a taxonomy set used by the user. Other taxonomy sets used to describe the data chunks by other users may be identified, and equivalency definitions may be obtained for portions of metadata used by the first user and the other users to describe the data chunks. By doing so, the equivalency definition may be used to translate terms present in a prompt issued by first user and/or the other users to be more likely to be understood by respective personal agents of the users that may use different taxonomy sets.

Turning to FIG. 2D, a fourth data flow diagram in accordance with an embodiment is shown. The fourth data flow diagram may illustrate data used in and data processing performed in servicing a query (e.g., query 200) by obtaining a response (e.g., response 228) to the query using an inference model (e.g., inference model 226).

To obtain response 228, ingest data package generation process 220 may be performed. During ingest data package generation process 220, query 200 and relevant data 216 (e.g., including the at least the first portion of the contextual information and the any other information obtained from user's data repository 204) may be compiled to obtain ingest data package 222. Ingest data package 222 may include a data structure indicating that relevant data 216 is to be used as context while generating a response to query 200 by an inference model. Therefore, the inference model may extract information from relevant data 216 included in ingest data package 222 and may base the response to query 200, at least in part, on the extracted information.

Ingest data package 222 may be a RAG output from a RAG pipeline process and may be usable as ingest for inference model 226. Inference model 226 may be a generative inference model (e.g., an LLM), and may include a neural network. Using ingest data package 222, response generation process 224 may be performed. During response generation process 224, generation of a response by inference model 226 may be initiated by feeding ingest data package 222 into inference model 226 to obtain response 228 as output from inference model 226.

Inference model 226 may generate response 228 to query 200 using relevant data 216 as context. Response 228 may include, for example, an answer to a question included in query 200, a desired information content indicated by query 200, and/or other information. Response 228 may include: (i) text, (ii) an image, (iii) a video, (iv) audio, and/or (v) other types of output that may be generated by inference model 226. Response 228 may be provided to the user (e.g., via the personal agent assigned to the user) as a customized service.

Thus, by implementing the data flows shown in FIGS. 2A-2D, a system in accordance with embodiments disclosed herein may have an increased likelihood of providing users responses to queries that meet the expectations of the users. Consequently, a resource cost (e.g., computational resources, time resources, cognitive resources) of obtaining the responses may be reduced.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2D may perform various methods to provide customized services to users of data processing systems. FIGS. 3A-3B illustrate a method that may be performed by the components of the system of FIGS. 1-2D. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of providing customized services to users of data processing systems in accordance with an embodiment is shown. The method may be performed, for example, by any of the components of the system of FIG. 1, and/or any other entity without departing from embodiments disclosed herein.

Prior to operation 300, a query may be obtained from a user for servicing by an artificial intelligence model. Contextual information may be attempted to be obtained and used to enhance a prompt to service the query.

At operation 300, an identification may be made that insufficient contextual information for a query is unavailable from a first data source. The identification may be made by (i) reading a result of the attempt to obtain the contextual information for the query from the first data source, (ii) receiving a notification from another entity indicating that the contextual information to sufficiently service the query is unavailable from the first data source, and/or (iii) any other methods.

At operation 302, a plurality of other data sources may be identified. The plurality of other data sources may be identified by (i) reading a list of other data sources from a database and/or other storage architecture, (ii) providing a request for the other data sources to another entity and receiving an identification of the other data sources in response, and/or (iii) performing any other methods. For example, identifying the plurality of the other data sources may include: (i) performing a look up process in a lookup table using an identifier for at least one other user as a key for the lookup table, (ii) obtaining, as a result of the lookup process, a data structure identifying at least one of the other data sources, (iii) reading the data structure identifying the plurality of the other data sources from storage, (iv) receiving the data structure identifying the plurality of the other data sources from another entity, and/or (v) any other methods.

At operation 304, it may be identified that at least a portion of the plurality of other data sources uses a different taxonomy set with respect to metadata for the portion of the plurality of other data sources. It may be identified that at least a portion of the plurality of other data sources uses a different taxonomy set by: (i) identifying characteristics of users associated with the other data sources (e.g., roles), (ii) receiving indication that an agent of a second data source does not understand at least a portion of a prompt (e.g., a term present in the prompt), and/or via any other processes.

At operation 306, a metadata translation process may be performed using an equivalency repository to obtain at least one translated prompt for the plurality of other data sources. The metadata translation process may be performed by: (i) generating, by a first agent of a first data source, a prompt based on the query to retrieve relevant data from a second agent of a second data source, (ii) performing a lookup in the equivalency repository using at least a portion of the prompt to obtain an equivalent definition for the second agent, (iii) replacing at least one term present in the prompt with a second term that is part of a taxonomy set used by the second agent, and/or via any other methods. The metadata translation process may also be performed by: (i) broadcasting, by the first agent, the prompt, (ii) identifying, by the receiving agents of the prompt, that at least one term present in the prompt is not in a taxonomy set used by a respective receiving agent, (iii) translating, by each receiving agent, the prompt to include a second term that is part of a taxonomy set used by the receiving agent, and/or performing any other actions. Refer to FIG. 3B for additional details regarding obtaining equivalency definitions for the equivalency repository.

At operation 308, supplemental contextual information obtained using the translated prompt from the other data sources. The supplemental contextual information may be obtained by (i) reading at least one data chunk from storage (e.g., from the other data sources), (ii) receiving the at least one data chunk from another entity (e.g., the management entity, a SME, and/or any other entity), and/or (iii) performing any other methods.

At operation 310, the query may be serviced using the at least the supplemental contextual information and any other information obtained from the first data source. The query may be serviced by (i) generating a response to the query using the at least the supplemental contextual information (and/or any other information obtained from the first data source), (ii) providing the response to the user via a graphical user interface, and/or (iii) performing any other methods.

The method may end following operation 310.

Turning to FIG. 3B, a second flow diagram illustrating a method of obtaining an equivalency definition for metadata in accordance with an embodiment is shown. The method may be performed, for example, by any of the components of the system of FIG. 1, and/or any other entity without departing from embodiments disclosed herein.

At operation 320, first metadata may be obtained for a data chunk from a first data source. The first metadata may be obtained by: (i) bookmarking the data chunk to indicate that the data chunk is important and/or relevant to a user of the first data source, (ii) tagging the data chunk with metadata to ascribe additional meaning and/or information to the data chunk using a first taxonomy set used by the user, (iii) applying, by a personal agent of the user, metadata based on historical metadata tagged by the user, and/or via any other processes.

At operation 322, second metadata may be obtained for the data chunk from a second data source. The second metadata may be obtained by: (i) performing a lookup in other data sources to identify metadata for the same and/or similar data of the data chunk, (ii) tagging, by second agents and/or a second user, the data chunk with metadata in a method similar the method used to tag the first metadata (e.g., described at operation 322), and/or via any other processes.

At operation 324, at least one portion of the first metadata and at least one second portion of the second metadata may be identified to be equivalent to obtain an equivalency definition. The at least one portion of the first metadata and the at least one second portion of the second metadata may be identified to be equivalent by: (i) automatically mapping the first metadata to the second metadata based on a policy for mapping metadata across different data sources, (ii) identifying relationships between terms used in the different data sources (e.g., using natural language processing), (iii) receiving equivalency definitions from a subject matter expert based on knowledge of the various taxonomy sets used in the different data sources, and/or via any other processes.

At operation 326, the equivalency definition may be stored in the equivalency repository so that the at least one portion of the first metadata and the at least one second portion of the second metadata are mutually translatable. The equivalency definition may be stored in the equivalency repository by: (i) adding an entry into a dictionary, (ii) establishing a link between a term of the first metadata and a second term of the second metadata, (iii) associating the first data source and second data source as using different taxonomy sets, and/or via any other processes.

The method may end following operation 326.

Thus, using the methods illustrated in FIGS. 3A-3B, embodiments disclosed herein may provide systems and methods usable to provide customized services to users of data processing systems so that responses to queries from the users have an increased likelihood of meeting the expectations of the users when the users may use different taxonomy sets.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO (Input/Output) devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing customized services to users of data processing systems, the method comprising:
making an identification that sufficient contextual information for a query is unavailable from a first data source;
based on the identification:
identifying a plurality of other data sources;
identifying that at least a portion of the plurality of other data sources uses a different taxonomy set with respect to metadata for the portion of the plurality of other data sources;
performing a metadata translation process using an equivalency repository to obtain at least one translated prompt for the plurality of other data sources;
obtaining, using the translated prompt, supplemental contextual information for the query from the other data sources; and
servicing the query using at least the supplemental contextual information and any other information obtained from the first data source.

2. The method of claim 1, further comprising:
obtaining, from the first data source, first metadata for a data chunk;
obtaining, from a second data source of the other data sources, second metadata for the data chunk;
identifying at least one portion of the first metadata and at least one second portion of the second metadata that are deemed to be equivalent to obtain an equivalency definition; and
storing the equivalency definition in the equivalency repository so that the at least one portion of the first metadata and the at least one second portion of the second metadata are mutually translatable.

3. The method of claim 2, wherein the first data source uses a first taxonomy set to describe a topic of the data chunk and the second data source uses a second taxonomy set to describe the topic of the data chunk.

4. The method of claim 3, further comprising:
identifying a new data chunk indicated to be of interest by a user of the first data source; and
obtaining metadata for the new data chunk.

5. The method of claim 4, wherein obtaining the metadata for the new data chunk comprises:
tagging, by an agent of the first data source, the new data chunk based on the first taxonomy set, the first taxonomy set being defined by the user of the first data source, and the second taxonomy set being defined by a different user.

6. The method of claim 1, wherein performing the metadata translation process comprises:
generating, by an agent of the first data source, a prompt based on the query to retrieve at least a portion of the supplemental contextual information from a second data source of the plurality of other data sources;
translating, by the agent, the prompt using the equivalency repository to obtain a translated prompt to be processed by a second agent of the second data source, the translated prompt comprising a term that is:
not present in the prompt,
indicated, by the equivalency repository, as equivalent to a second term that is present in the prompt, and
part of a second taxonomy set used the second agent; and
providing the translated prompt to the second agent.

7. The method of claim 1, wherein performing the metadata translation process comprises:
generating, by an agent of the first data source, a prompt based on the query to retrieve at least a portion of the supplemental contextual information from a second data source of the plurality of other data sources;
providing, by the agent, the prompt to a second agent of the second data source; and
translating, by the second agent, the prompt using the equivalency repository to obtain the translated prompt, the translated prompt comprising a term that is:
not present in the prompt,
indicated, by the equivalency repository, as equivalent to a second term that is present in the prompt, and
part of a second taxonomy set used the second agent.

8. The method of claim 1, wherein the metadata indicates hierarchical information based on content of data chunks hosted by data sources, the data chunks being deemed relevant by the users.

9. The method of claim 8, wherein the hierarchical information indicates a version of a topic to which a data chunk of the data chunks relates.

10. The method of claim 1, wherein the first data source is associated with a user of the users and managed by a first agent assigned to the user, the first data source serving as a personal context library for the user for queries submitted to the first agent.

11. The method of claim 10, wherein the supplemental contextual information is used along with a prompt as input to an artificial intelligence model of the first agent.

12. A non-transitory machine-readable medium having instructions stored therein, which when executed by a processor, cause the processor to perform operations for providing customized services to users of data processing systems the operations comprising:
making an identification that sufficient contextual information for a query is unavailable from a first data source;
based on the identification:
identifying a plurality of other data sources;
identifying that at least a portion of the plurality of other data sources uses a different taxonomy set with respect to metadata for the portion of the plurality of other data sources;
performing a metadata translation process using an equivalency repository to obtain at least one translated prompt for the plurality of other data sources
obtaining, using the translated prompt, supplemental contextual information for the query from the other data sources; and
servicing the query using at least the supplemental contextual information and any other information obtained from the first data source.

13. The non-transitory machine-readable medium of claim 12, wherein the operations further comprise:
obtaining, from the first data source, first metadata for a data chunk;
obtaining, from a second data source of the other data sources, second metadata for the data chunk;
identifying at least one portion of the first metadata and at least one second portion of the second metadata that are deemed to be equivalent to obtain an equivalency definition; and
storing the equivalency definition in the equivalency repository so that the at least one portion of the first metadata and the at least one second portion of the second metadata are mutually translatable.

14. The non-transitory machine-readable medium of claim 13, wherein the first data source uses a first taxonomy set to describe a topic of the data chunk and the second data source uses a second taxonomy set to describe the topic of the data chunk.

15. The non-transitory machine-readable medium of claim 14, wherein the operations further comprise:
identifying a new data chunk indicated to be of interest by a user of the first data source; and
obtaining metadata for the new data chunk.

16. The non-transitory machine-readable medium of claim 15, wherein obtaining the metadata for the new data chunk comprises:
tagging, by an agent of the first data source, the new data chunk based on the first taxonomy set, the first taxonomy set being defined by the user of the first data source, and the second taxonomy set being defined by a different user.

17. A data processing system, comprising:
a processor; and
a memory coupled to the processor to store instructions, which when executed by the processor, cause the processor to perform operations for providing customized services to users of data processing systems, the operations comprising:
making an identification that sufficient contextual information for a query is unavailable from a first data source;
based on the identification:
identifying a plurality of other data sources;
identifying that at least a portion of the plurality of other data sources uses a different taxonomy set with respect to metadata for the portion of the plurality of other data sources;
performing a metadata translation process using an equivalency repository to obtain at least one translated prompt for the plurality of other data sources;
obtaining, using the translated prompt, supplemental contextual information for the query from the other data sources; and
servicing the query using at least the supplemental contextual information and any other information obtained from the first data source.

18. The data processing system of claim 17, wherein the operations further comprise:
obtaining, from the first data source, first metadata for a data chunk;
obtaining, from a second data source of the other data sources, second metadata for the data chunk;
identifying at least one portion of the first metadata and at least one second portion of the second metadata that are deemed to be equivalent to obtain an equivalency definition; and
storing the equivalency definition in the equivalency repository so that the at least one portion of the first metadata and the at least one second portion of the second metadata are mutually translatable.

19. The data processing system of claim 18, wherein the first data source uses a first taxonomy set to describe a topic of the data chunk and the second data source uses a second taxonomy set to describe the topic of the data chunk.

20. The data processing system of claim 19, wherein the operations further comprise:
identifying a new data chunk indicated to be of interest by a user of the first data source; and
obtaining metadata for the new data chunk.
